(19) United States
(12) Patent Application Publication
(10) Pub. No.: US 2004/0048110 A1
(43) Pub. Date: Mar. 11, 2004

(54) Wallboard comprising an improved multi-layer facing material and a method for making the same

(76) Inventor: Steven Butler, Green Cove Springs, CO (US)

Correspondence Address: William C. Rowland, BURNS, DOANE, SWECKER & MATHIS, L.L.P., P.O. Box 1404, Alexandria, VA, 22313-1404, US

(21) Appl. No.: 10/237,186

(22) Filed: Sep. 9, 2002

(51) Int. Cl. B32B 27/12; B32B 27/04; D03D 15/00; D04C 1/00; D04B 1/00; D03D 9/00

(52) U.S. Cl. 428/920; 442/35; 442/42; 442/49; 442/136; 427/376.2

(57) ABSTRACT

A wallboard includes a set cementitious core, and (ii) at least a composite facing material on at least one of the faces of the core, the facing material including: (a) a synthetic scrim, and adhered thereto, (b) a synthetic non-woven; the scrim being completely embedded in the core while the synthetic non-woven is at most partially embedded in the core. A process for making such a wall board, in which the viscosity of the cementitious slurry is controlled on the facing material such that the scrim is completely embedded in the core while the synthetic non-woven is at most partially embedded in the core.

### BACKGROUND OF THE INVENTION

The invention relates to wallboards, also known as dry-wall or plasterboard, comprising a specific facing material, and a method for making the same. Typical wallboard comprises a gypsum core and usually two facing material which may be paper or a glass mat. Glass mat facing materials are used in applications such as fire-resistant wallboards and EIS (Exterior Insulating Sheathing).

U.S. Pat. No. 4,504,533 discloses a gypsum wallboard comprising a composite non-woven (mineral wool) layer and woven fiber glass scrim construction. In this construction, the glass scrim is embedded in the in the gypsum core, while the non-woven is prevents or hinders the passage of the gypsum slurry (it is however indicated that the gypsum slurry may slightly into it).

Georgia-Pacific patents U.S. Pat. No. 4,647,496 and U.S. Pat. No. 4,810,569 also discloses such a wallboard, where the facing material is a glass mat (non-woven), wherein the outer surface of said mat being substantially free of set gypsum. Said wallboards are said to be suitable for EIS (Exterior Insulation System).

U.S. Pat. No. 4,948,647 discloses a wallboard having a facer consisting of a mineral woven scrim and a mineral non-woven, coated with a water-based latex-provided film. This wallboard is suited for use in wet area, esp. for receiving tiles.

All of these wallboards use glass, which is known to be a very irritating material. Hence, there is a need for a facing material that would comprise substantially no glass but would at the same time be suitable for the same applications, i.e. outdoors and indoors.

### OBJECTS AND SUMMARY

This, and other objects, are achieved by the invention which provides an all-synthetic solution. Hence, the subject of the invention is a wallboard comprising:

a set cementitious core, and

at least a composite facing material on at least one of the faces of said core, said facing material comprising: (a) a synthetic scrim, and adhered thereto, (b) a synthetic non-woven, the scrim being completely embedded in said core while the synthetic non-woven is at most partially embedded in said core.

The preferred embodiment is a wallboard in which the core is a gypsum core, and the synthetic non-woven is partially embedded in said core.

### BRIEF DESCRIPTION OF THE DRAWINGS

FIG. 1 is a cross-section representation of a preferred embodiment of the invention.

### DETAILED DESCRIPTION OF THE PREFERRED EMBODIMENTS

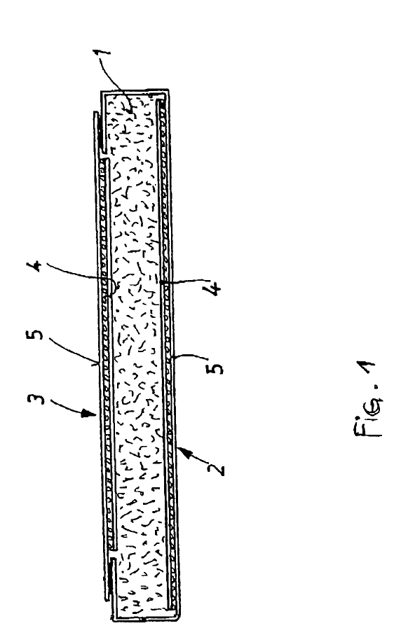

The wallboard of FIG. 1 comprises a core 1. Usually the core will be a gypsum core, but other materials may be used, esp. cement. Gypsum is preferred. The core will preferably comprise additives, esp. water-resistance additives (polyvinylalcohol, silicone, wax, asphalt, etc., as disclosed in U.S. Pat. No. 4,647,496, incorporated herein by reference), fire-resistance additives (glass fibers, etc., as disclosed in U.S. Pat. No. 4,647,496, incorporated herein by reference), preferably both. Amounts thereof will be adjusted so as to meet the local regulations requirements, as the skilled will easily appreciate.

The facing materials 2 and 3 are on the lower and upper faces of the wallboard, respectively. According to one embodiment, both facing materials are identical and according to the present invention. According to another embodiment, one facer only is according to the invention while the other facer is a traditional facer, in such end uses that require specific surface requirements only on one face or different requirements on each face.

The facing material comprises a woven scrim 4 and a non-woven 5. The scrim 4 will impart the mechanical properties to the board. It comprises synthetic fibers. Such synthetic fibers can be polyamide fibers, esp. aramide fibers (such as those produced by E.I. DuPont, Wilmington, Del.). Examples are Kevlar® fibers. This scrim will be embedded in the core material. The scrim may comprise various patterns, and the yarns have a denier and the threads a distribution of openings (dimension of the spaces between the threads) that the skilled man may easily determine. For example, the denier is from 100 to 2500, while the surface of the free area (between the threads) is comprised from e.g. 1 mm² to 1000 mm^{2.}

The non-woven material is obtained from a synthetic yarn. It may be of various sources, and preferably polyester. Non-wovens are known in the art. Many patents have been issued to E.I. DuPont, Wilmington, Del., in this field, and the skilled man advantageously refer to them. Non-woven suppliers are known. The surface weight of the non-woven may vary within broad limits, already known in the art. For example, the weight may be from 10 to 250 g/m².

The values reported in U.S. Pat. No. 4,948,647 (incorporated herein by reference) are applicable in the instant case. The scrim is adhered to the non-woven using conventional techniques and/or adhesives known in the art.

According to the preferred embodiments, it is possible to avoid glass in the facing material, thus rendering the wallboards users-friendly. The facing material may comprise the scrim over a surface that is smaller than the one of the non-woven. In such a case, the non-woven will provide clean edges, since it is easier to fold, compared to the composite per se. This embodiment is disclosed in U.S. Pat. No. 4,504,533, col. 2, incorporated herein by reference.

The wallboards of the preferred embodiments of the invention may further receive a resin coat or a skim-coat, such as the one disclosed in WO-A-02012144 and WO-A-02058902, the entire content thereof being incorporated by reference. Resin may be added to the coating material of these references to further enhance the properties of the final board.

The preferred embodiment also includes a process, which can be implemented on a standard wallboard line. The facing material will be provided on the forming belt, and/or on the upper roll. The facing material may be substituted, virtually without any machine adaptations, to existing facing materials (esp. when these facing materials are glass mats). The facing material will be provided such that the scrim will be adjacent to the core, the non-woven being on the outer face.

According to a preferred embodiment, the viscosity will be controlled so that the scrim is completely embedded in said core while the synthetic non-woven is at most partially embedded in said core. According to this embodiment, it is desired that the core materials does not fully penetrate the facing material, leaving the non-woven exposed at its outer surface. For example, the core material will penetrate from 10% up to 90%, esp. 40% to 75% of the thickness of the non-woven.

The invention is not limited to the embodiments disclosed but can be varied as the skilled man would appreciate and is defined in the appended claims.

1. A wallboard comprising:
a set cementitious core, and
at least a composite facing material on at least one of the faces of said core, said facing material comprising: (a) a synthetic scrim, and adhered thereto, (b) a synthetic non-woven,
the scrim being completely embedded in said core while the synthetic non-woven is at most partially embedded in said core.

2. The wallboard of claim 1, wherein the non-woven is partially embedded in the core.

3. The wallboard of claim 1, wherein the core material will penetrate from 10% up to 90% of the thickness of the non-woven.

4. The wallboard of claim 1, wherein the core material will penetrate from 40% up to 75% of the thickness of the non-woven.

5. The wallboard of claim 1, wherein the non-woven is not embedded in the core.

6. The wallboard of claim 1, wherein the cementitious core is a gypsum core.

7. The wallboard of claim 1, wherein the core comprises at least one water-resistance additive, at least one fire-resistance additive, or both.

8. The wallboard of claim 1, wherein the non-woven comprises polyester fibers.

9. The wallboard of claim 1, wherein the scrim comprises polyamide fibers.

10. A wallboard comprising:
a set gypsum core, and
at least a composite facing material on at least one of the faces of said core, said facing material comprising: (a) a synthetic scrim, and adhered thereto, (b) a synthetic non-woven,
the scrim being completely embedded in said core while the synthetic non-woven is partially embedded in said core.

11. The wallboard of claim 10, wherein the core material will penetrate from 10% up to 90% of the thickness of the non-woven.

12. The wallboard of claim 10, wherein the core material will penetrate from 40% up to 75% of the thickness of the non-woven.

13. The wallboard of claim 10, wherein the core comprises at least one water-resistance additive, at least one fire-resistance additive, or both.

14. The wallboard of claim 10, wherein the non-woven comprises polyester fibers.

15. The wallboard of claim 10, wherein the scrim comprises polyamide fibers.

16. A wallboard comprising:
a set gypsum core, the core further comprising at least one water-resistance additive, at least one fire-resistance additive, or both; and
at least a composite facing material on at least one of the faces of said core, said facing material comprising: (a) a synthetic scrim, and adhered thereto, (b) a synthetic non-woven,
the scrim being completely embedded in said core while the synthetic non-woven is partially embedded in said core, the core material penetrating from 10% up to 90% of the thickness of the non-woven.

17. The wallboard of claim 16, wherein the core material will penetrate from 40% up to 75% of the thickness of the non-woven.

18. The wallboard of claim 16, wherein the non-woven comprises polyester fibers.

19. The wallboard of claim 16, wherein the scrim comprises polyamide fibers.

20. A method for making a wallboard, comprising the steps of:
providing a composite facing material comprising: (a) a synthetic scrim, and adhered thereto, (b) a synthetic non-woven,
depositing a cementitious slurry on said material, the slurry being deposited on the scrim side of said facing material,
the viscosity of said slurry being controlled so that the scrim is completely embedded in said core while the synthetic non-woven is at most partially embedded in said core.

21. The method of claim 20, wherein the viscosity of said slurry is controlled so that the synthetic non-woven is partially embedded in said core.

22. The method of claim 20, for the manufacture of a wallboard comprising (i) a set cementitious core, and (ii) at least a composite facing material on at least one of the faces of said core, said facing material comprising: (a) a synthetic scrim, and adhered thereto, (b) a synthetic non-woven, the scrim being completely embedded in said core while the synthetic non-woven is partially embedded in said core.

23. The method of claim 20, for the manufacture of a wallboard comprising (i) a set gypsum core, the core further comprising at least one water-resistance additive, at least one fire-resistance additive, or both; and (ii) at least a composite facing material on at least one of the faces of said core, said facing material comprising: (a) a synthetic scrim, and adhered thereto, (b) a synthetic non-woven, the scrim being completely embedded in said core while the synthetic non-woven is partially embedded in said core, the core material penetrating from 10% up to 90% of the thickness of the non-woven.
